(19) United States
(12) Patent Application Publication
(10) Pub. No.: US 2015/0192207 A1
(43) Pub. Date: Jul. 9, 2015

(54) SHAFT SEAL ASSEMBLY FOR FINAL DRIVE SYSTEM

(71) Applicant: Caterpillar Inc., Peoria, IL (US)

(72) Inventor: TIMOTHY S. STOAKES, NAPERVILLE, IL (US)

(73) Assignee: Caterpillar Inc., Peoria, IL (US)

(21) Appl. No.: 14/662,257

(22) Filed: Mar. 19, 2015

(51) Int. Cl. F16J 15/16; F16C 33/78; F16C 35/12; B60B 35/16; B60B 35/18

(52) U.S. Cl. CPC F16J 15/16; B60B 35/16; B60B 35/18; F16C 35/12; F16C 33/783; F16C 33/784; B60B 2900/511; B60Y 2200/415

(57) ABSTRACT

A final drive system includes a spindle, an axle shaft, a planetary gear assembly, and a bearing assembly. The bearing assembly includes a bearing retainer plate and a shaft seal assembly. The shaft seal assembly seals the axle shaft with the bearing retainer plate. The shaft seal assembly includes a first side, second side, a housing member, bearing members, a sleeve member, and seal member. The housing member is removably attached and coaxially disposed to the bearing retainer plate. The bearing members are coaxially attached to the housing member. The sleeve member is coaxially attached to the bearing member and is removably attached to the axle shaft. The seal member is disposed between the sleeve member and the housing member proximal to the first side. The removable attachment of the housing member facilitates removal of the shaft seal assembly and access to the seal member through the first side.

### TECHNICAL FIELD

The present disclosure relates generally to a final drive system for machines. More specifically, the present disclosure relates to a removable shaft seal assembly for the final drive system.

### BACKGROUND

Various machines, such as wheel loaders, are known to employ a final drive system to transfer engine torque from an engine to a wheel of the machine, while obtaining speed reduction. Final drive systems commonly include a spindle, a wheel housing, an axle shaft, and at least one planetary gear assembly. Such planetary gear assemblies are positioned in a gear compartment defined within the wheel housing. Generally, the axle shaft passes through an interior of the spindle and extends axially, to connect with the planetary gear assembly. More often than not, the gear compartment is at least partially filled with lubrication oil, to lubricate the planetary gear assembly positioned within the gear compartment. This lubrication oil is likely to leak from the gear compartment to the interior of the spindle. A bearing assembly is mounted at an interface formed between the gear compartment and the interior of the spindle, and includes a shaft seal assembly at the interface that prevents lubrication leakage.

Conventionally, bearing assemblies include a bearing retainer plate with a through hole to permit an operable passage of the axle shaft through the through hole. The shaft seal assembly is commonly fixedly mounted within this through hole and is adapted to seal the axle shaft, which passes through the bearing retainer plate. The shaft seal assembly commonly includes a bearing member and a seal member. During prolonged and continuous operation, the seal member may wear out and require service and/or replacement. For this purpose, it may be required to access the seal member. Such an access may be accomplished by a removal of the bearing assembly from the final drive system. More specifically, the bearing retainer plate, along with the shaft seal assembly, is removed from the final drive system for repair and/or replacement of the seal member. For removal of the bearing retainer plate, the wheel housing and the wheel are disassembled from the final drive system, which may be a cumbersome task for the service person. In addition, this increases the service cost and effort.

U.S. Pat. No. 4,491,0137 discloses a planetary reduction drive unit to transfer torque from a transmission shaft to an output member, through a sleeve member. Although this reference discloses a seal that seals the sleeve member in each of an extended position and a retracted position, this reference does not provide a seal that may be repaired and/or replaced without disassembly of the wheel from the machine.

### SUMMARY OF THE INVENTION

Various aspects of the present disclosure illustrate a bearing assembly for a final drive system. The final drive system includes a spindle, an axle shaft, and at least one planetary gear assembly. The spindle has a first end, a second end, and a longitudinal axis. The axle shaft is disposed within the spindle along the longitudinal axis and extends at least partially outwards from the second end of the spindle to connect with the at least one planetary gear assembly. The bearing assembly includes a bearing retainer plate and a shaft seal assembly. The bearing retainer plate is attached to the second end of the spindle and has a through hole. Notably, the axle shaft of the final drive system extends through the through hole of the bearing retainer plate to axially connect with the at least one planetary gear assembly. The shaft seal assembly has a first side and a second side and is adapted to seal the axle shaft with the bearing retainer plate. The shaft seal assembly is removably attached and is coaxially disposed within the through hole of the bearing retainer plate. The shaft seal assembly includes a housing member, at least one bearing member, a sleeve member, a seal member, and a radial O-ring. The housing member has an inner peripheral portion and is removably attached and coaxially disposed within the through hole of the bearing retainer plate. The at least one bearing member is coaxially attached to the inner peripheral portion of the housing member. The sleeve member is coaxially attached to the at least one bearing member and is removably attached to the axle shaft. The sleeve member is rotatable relative to the housing member. The seal member is disposed between the sleeve member and the housing member, proximal to the first side of the shaft seal assembly. The radial O-ring is disposed between the sleeve member and the axle shaft, proximal to the second side of the shaft seal assembly. The removable attachment of the housing member facilitates removal of the shaft seal assembly from the bearing retainer plate and access to the seal member through the first side of the shaft seal assembly.

### BRIEF DESCRIPTION OF THE DRAWINGS

FIG. 1 is a perspective view of a machine with a final drive system, in accordance with the concepts of the present disclosure;

FIG. 2 is a cross-sectional side view of the final drive system of the machine of FIG. 1 that illustrates various components of the final drive system, in accordance with the concepts of the present disclosure;

FIG. 3 is an enlarged view of a portion of the final drive system of FIG. 2 that illustrates a bearing assembly with a shaft seal assembly, in accordance with the concepts of the present disclosure; and

FIG. 4 is a cross-sectional perspective view of the final drive system, in accordance with the concepts of the present disclosure.

### DETAILED DESCRIPTION

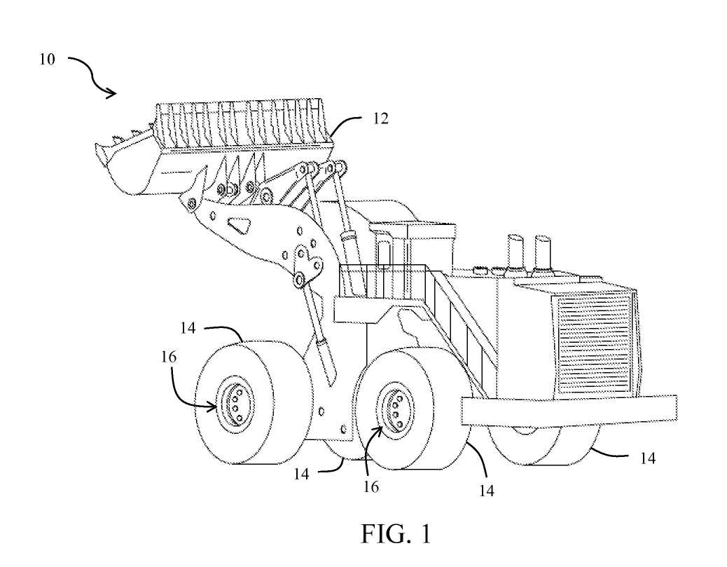

Referring to FIG. 1, there is shown a perspective view of a machine 10. The machine 10 may embody a construction machine, a forest machine, and/or any other similar machine. In the present disclosure, the machine 10 is depicted as a wheel loader. However, it may be noted that the concepts of the present disclosure may not be limited to the wheel loader and may be applied to a wheeled excavator, a motor grader, and/or the like.

The machine 10 is equipped with a work implement 12 to perform a multiplicity of operations, such as but not limited to, an excavation operation, a digging operation, and/or a material transfer operation. To facilitate these operations, the machine 10 traverses from one place to another. For this purpose, the machine 10 is equipped with a number of wheels 14. Each wheel 14 of the machine 10 is connected to and powered by an engine (not shown) of the machine 10, via a final drive system 16. The final drive system 16 is adapted to transfer engine torque to the wheel 14 of the machine 10, while obtaining speed reduction.

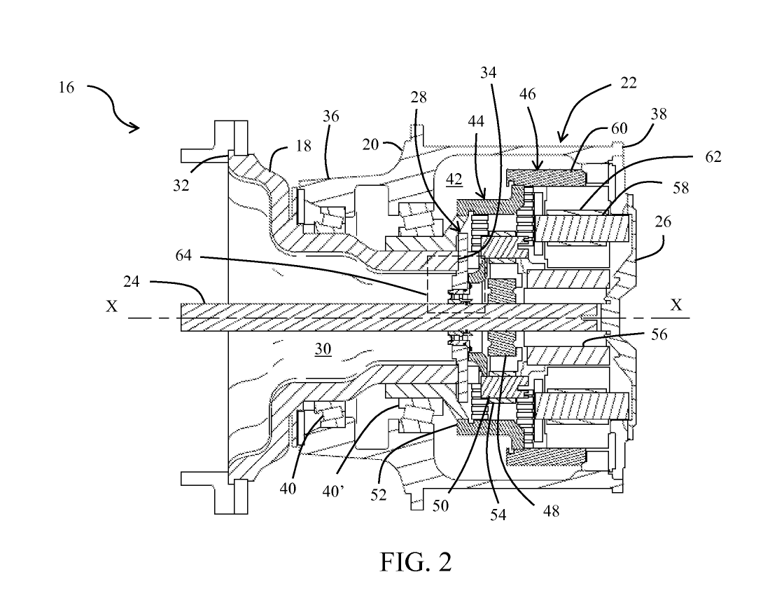

Referring to FIG. 2, there is shown the final drive system 16 of the machine 10. The final drive system 16 includes a spindle 18, a wheel housing 20, at least one planetary gear assembly 22, an axle shaft 24, a final drive cover plate 26, and a bearing assembly 28.

The spindle 18 and the wheel housing 20 are adapted to house the planetary gear assembly 22, the axle shaft 24, and the bearing assembly 28. The spindle 18 may be a hollow-elongated member that includes an interior space 30, defined along entire length of the spindle 18. Moreover, the spindle 18 includes a first end 32, a second end 34, and a longitudinal axis X-X. The first end 32 of the spindle 18 may be fixedly attached to a frame (not shown) of the machine 10, and is kept stationary.

The wheel housing 20 includes a first end portion 36 and a second end portion 38. The wheel housing 20 is co-axially and rotatably supported with the spindle 18, at the first end portion 36. It may be noted that the first end portion 36 may be rotatably supported on the spindle 18, with use of a pair of wheel bearings 40, 40′. In assembly, the second end portion 38 of the wheel housing 20 axially extends beyond the second end 34 of the spindle 18 and is covered by the final drive cover plate 26. This arrangement of the wheel housing 20 and the spindle 18, defines a gear compartment 42 within the wheel housing 20, beyond the second end 34 of the spindle 18. More specifically, the second end 34 of the spindle 18 forms an interface between the gear compartment 42 and the interior space 30 of the spindle 18. Moreover, the wheel housing 20 supports the wheel 14 of the machine 10 and a rotational movement of the wheel housing 20 corresponds to rotation of the wheel 14.

The planetary gear assembly 22 is positioned in the gear compartment 42 and is fixedly connected to the wheel housing 20. The planetary gear assembly 22 includes a first planetary gear assembly 44 and a second planetary gear assembly 46.

The first planetary gear assembly 44 includes a first sun gear 48, a first set of planetary gears 50, a first ring gear 52, and a first carrier 54. The first sun gear 48, the first set of planetary gears 50, the first ring gear 52, and the first carrier 54 are arranged such that a rotational movement of the first sun gear 48 corresponds to a rotational movement of the first carrier 54. Similar to the first planetary gear assembly 44, the second planetary gear assembly 46 also includes a second sun gear 56, a second set of planet gears 58, a second ring gear 60, and a second carrier 62. The second sun gear 56, the second set of planet gears 58, the second ring gear 60, and the second carrier 62 are arranged in a manner, such that a rotational movement of the second sun gear 56 corresponds to a rotational movement of the second carrier 62. Moreover, the first carrier 54 of the first planetary gear assembly 44 is attached to the second sun gear 56 of the second planetary gear assembly 46. In addition, the second carrier 62 of the second planetary gear assembly 46 is attached to the wheel housing 20 of the final drive system 16. This arrangement of the first planetary gear assembly 44, the second planetary gear assembly 46, and the wheel housing 20 facilitates rotation of the wheel housing 20 corresponding to the rotational movement of the first sun gear 48.

The axle shaft 24 may be an elongated rod member that extends between the engine (not shown) and the planetary gear assembly 22 of the final drive system 16. The axle shaft 24 passes through the interior space 30 of the spindle 18 and extends beyond the second end 34 of the spindle 18, to connect with the first sun gear 48 of the first planetary gear assembly 44. Therefore, a rotational movement of the axle shaft 24 facilitates rotation of the first sun gear 48 and correspondingly rotation of the wheel housing 20.

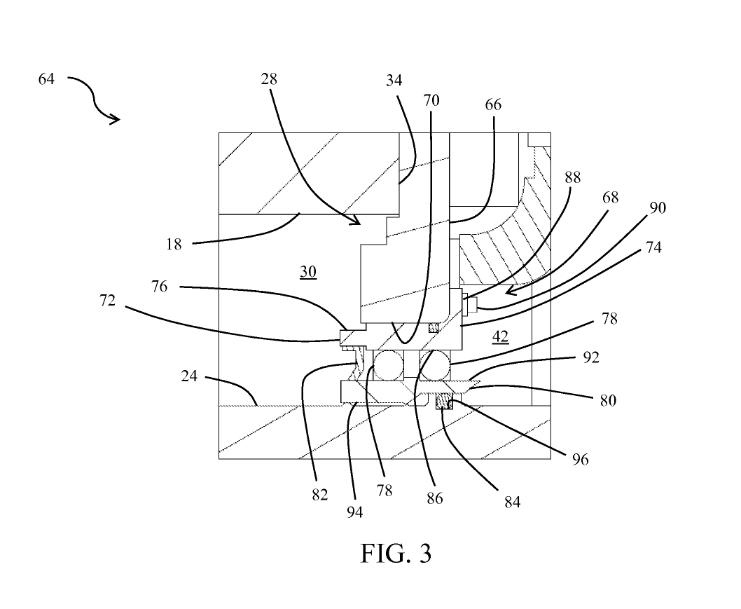

Furthermore, it may be noted that the gear compartment 42 is filled with lubrication oil, which facilitates lubrication of the planetary gear assembly 22. The gear compartment 42 is required to be sealed at the second end 34 of the spindle 18, to prevent leakage of lubrication oil from the gear compartment 42 to the interior space 30 of the spindle 18, through the second end 34. For this purpose, the final drive system 16 is equipped with the bearing assembly 28 that includes a shaft seal assembly 68 (FIG. 3), to limit fluid communication between the gear compartment 42 and the interior space 30 of the spindle 18.

Referring to FIG. 3, there is shown a portion 64 of the final drive system 16 that illustrates the bearing assembly 28. The bearing assembly 28 is mounted on the second end 34 of the spindle 18. The bearing assembly 28 includes a bearing retainer plate 66 and the shaft seal assembly 68.

The bearing retainer plate 66 is adapted to retain the wheel bearings 40, 40′. The bearing retainer plate 66 is attached to the second end 34 of the spindle 18 and includes a through hole 70. Notably, the axle shaft 24 extends through the through hole 70, to connect with the planetary gear assembly 22.

The shaft seal assembly 68 is removably attached and coaxially disposed within the through hole 70 of the bearing retainer plate 66. The shaft seal assembly 68 is adapted to seal the axle shaft 24 to the bearing retainer plate 66. The shaft seal assembly 68 has a first side 72 and a second side 74. Moreover, the shaft seal assembly 68 includes a housing member 76, at least one bearing member 78, a sleeve member 80, a seal member 82, and a radial O-ring 84.

The housing member 76 may be castle-shaped with an inner peripheral portion 86. The housing member 76 is removably attached to the bearing retainer plate 66. More specifically, the housing member 76 includes a flange portion 88 removably attached to the bearing retainer plate 66, with use of a number of bolted fasteners 90. In so doing, the housing member 76 is coaxially disposed within the through hole 70 of the bearing retainer plate 66. Although the present disclosure contemplates usage of bolted fasteners 90 to attach the housing member 76 at the bearing retainer plate 66, several other attachment means, such as a snap attachment and/or a fit attachment, may also be envisioned.

The bearing members 78 may be roller bearings coaxially attached to the inner peripheral portion 86 of the housing member 76. The bearing members 78 are shown to be two in number. However, usage of a varying number of bearing members 78 may be contemplated.

The sleeve member 80 may be a hollow cylindrical member with an outer circumferential portion 92 and an inner circumferential portion 94. The outer circumferential portion 92 is coaxially attached to the bearing members 78. The inner circumferential portion 94 is removably attached to the axle shaft 24. Therefore, the sleeve member 80 is rotatable relative to the housing member 76 of the shaft seal assembly 68. The inner circumferential portion 94 of the sleeve member 80 may be attached to the axle shaft 24 by a mechanical arrangement, such as but not limited to, a key arrangement, a spline arrangement, and/or the like.

The seal member 82 is a lip-type seal disposed between the sleeve member 80 and the housing member 76. In assembly, the seal member 82 is positioned proximal to the first side 72 of the shaft seal assembly 68. This facilitates a seal between the sleeve member 80 and the housing member 76. Notably, the seal between the sleeve member 80 and the housing member 76 facilitates seal of the bearing members 78.

The radial O-ring 84 is positioned between the sleeve member 80 and the axle shaft 24, proximal to the second end 74 of the shaft seal assembly 68. More specifically, the radial O-ring 84 may be retained in a groove 96 defined on the axle shaft 24. This facilitates a seal between the sleeve member 80 and the axle shaft 24.

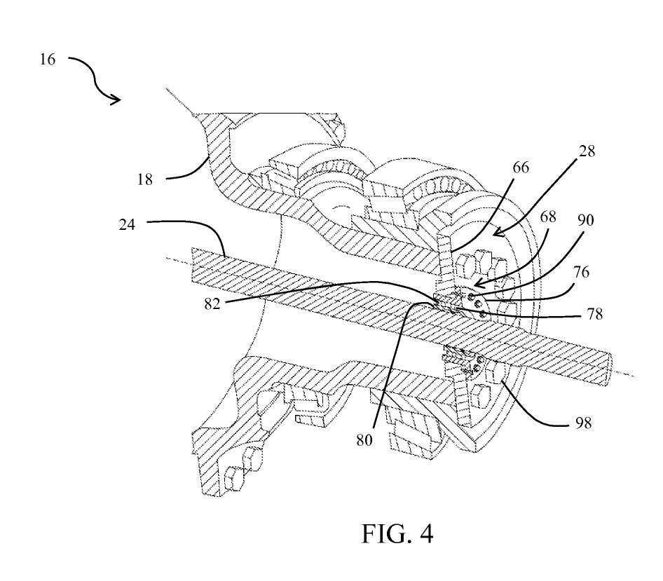

Referring to FIG. 4, there is shown an exemplary cross-sectional view of the final drive system 16 of the machine 10. The final drive system 16 is shown with the wheel housing 20 and the planetary gear assembly 22 removed to better comprehend the assembly between the spindle 18 and bearing assembly 28. As shown, the bearing assembly 28 is secured to the second end 34 of the spindle 18, by bolted fasteners 98. Several other attachment means for attachment of the bearing assembly 28 to the spindle 18, such as a snap attachment and/or a fit attachment may also be envisioned. Moreover, an engagement of the shaft seal assembly 68 via the flange portion 88 with the bearing retainer plate 66 and the axle shaft 24 is also illustrated. The shaft seal assembly 68 is also removably attached to the bearing retainer plate 66 of the bearing assembly 28, with use of the bolted fasteners 90. The removable attachment of the shaft seal assembly 68 relative to the bearing retainer plate 66 facilitates removal of the shaft seal assembly 68 from the final drive system 16, whenever required.

### INDUSTRIAL APPLICABILITY

In operation, an assembly of the housing member 76, the sleeve member 80 and the bearing members 78 of the shaft seal assembly 68 facilitate rotation of the axle shaft 24, within the second end 34 of the spindle 18. Moreover, the seal member 82 and the radial O-ring 84 of the shaft seal assembly 68 restricts flow of lubrication oil from the gear compartment 42 to the interior space 30 of the spindle 18, to prevent leakage of lubrication oil through the second end 34. The seal member 82 restricts flow of lubrication oil though the bearing members 78 of the shaft seal assembly 68, while the radial O-ring 84 restricts flow of lubrication oil through a space between the sleeve member 80 and the axle shaft 24. Therefore, a leakage of lubrication oil through the second end 34 of the spindle 18 is prevented. During prolonged and continuous operation, the seal member 82 may be damaged and may require repair and/or replacement. To service and/or repair the seal member 82, the shaft seal assembly 68 may be disassembled from the bearing retainer plate 66.

The methodology of disassembling the shaft seal assembly 68 initiates with removal of the planetary gear assembly 22 from the final drive system 16. After removal of the planetary gear assembly 22, the axle shaft 24 is removed from the final drive system 16 by provision of a pull force along the longitudinal axis X-X. As the housing member 76 is removably attached to the bearing retainer plate 66, the shaft seal assembly 68 is detached by removal of the housing member 76 from the bearing retainer plate 66. More specifically, the housing member 76 may be removed by unscrewing the bolted fasteners 90 from the bearing retainer plate 66. This enables an access to the seal member 82 through the first side 72 of the shaft seal assembly 68. In this way, the seal member 82 may be repaired and/or replaced. The shaft seal assembly 68 may then be reinstalled on the final drive system 16 to be reused. Notably, in the present disclosure, the shaft seal assembly 68 is detached without removal of the wheel housing 20 and the wheel 14 of the machine 10. This reduces the service cost of the machine 10.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A bearing assembly for a final drive system, the final drive system including a spindle, an axle shaft, and at least one planetary gear assembly, the spindle having a first end, a second end, and a longitudinal axis, the axle shaft being disposed within the spindle along the longitudinal axis and extending at least partially outwards of the second end of the spindle to connect with the at least one planetary gear assembly, the bearing assembly including:
a bearing retainer plate attached to the second end of the spindle, the bearing retainer plate having a through hole therein, wherein the axle shaft extends through the through hole of the bearing retainer plate to axially connect with the at least one planetary gear assembly; and
a shaft seal assembly having a first side and a second side, the shaft seal assembly being removably attached and coaxially disposed within the through hole of the bearing retainer plate and adapted to seal the axle shaft with the bearing retainer plate, the shaft seal assembly including:
a housing member removably attached and coaxially disposed within the through hole of the bearing retainer plate, the housing member having an inner peripheral portion;
at least one bearing member coaxially attached to the inner peripheral portion of the housing member;
a sleeve member coaxially attached to the at least one bearing member and being removably attached to the axle shaft, the sleeve member being rotatable relative to the housing member;
a seal member disposed between the sleeve member and the housing member proximal to the first side of the shaft seal assembly; and
a radial O-ring disposed between the sleeve member and the axle shaft proximal to the second side of the shaft seal assembly, wherein the removable attachment of the housing member facilitates removal of the shaft seal assembly from the bearing retainer plate and access to the seal member through the first side of the shaft seal assembly.
